(19) United States
(12) Patent Application Publication
(10) Pub. No.: US 2002/0032598 A1
(43) Pub. Date: Mar. 14, 2002

(54) Apparatus and process for evaluating survey data

(76) Inventors: Peter Grant, Melbourne (AU); Gary C. Morgan, Melbourne (AU)

Correspondence Address: Max Stul Oppenheimer, P. O. Box 50, Stevenson, MD, 21153, US

(21) Appl. No.: 09/833,199

(22) Filed: Apr. 11, 2001

Related U.S. Application Data
(60) Provisional application No. 60/196,853, filed on Apr. 12, 2000.

(51) Int. Cl. G06F 17/60

(52) U.S. Cl. 705/10

(57) ABSTRACT

A method for determining an opportunities-to-see (“OTS”) distribution of a schedule of print or television media, comprises the steps of generating individual OTS distributions based on loyalty and casualness, wherein loyalty is a representation of the probability that an individual will read a print publication or view a television program according to a binomial distribution, and wherein casualness is the ratio of the additional reach of a succeeding issue over the reach of its preceeding issue to the additional reach of said succeeding isssue to an independent issue; and summing said individual OTS distributions.

### FIELD AND BACKGROUND OF THE INVENTION

1. Field of the Invention

The present invention relates in general to data analysis, and more particularly to analysis of data relating to consumer, viewership, readership and circulation surveys.

2. Background Information

Background Information is presented in the Attached Documents.

### SUMMARY OF THE INVENTION

The invention, its objects, features and advantages are summarized in the Attached Documents.

### DESCRIPTION OF THE PREFERRED EMBODIMENT

The currently envisioned preferred embodiment is set forth in the Attached Documents.

What is claimed is:

1. A method for determining an opportunities-to-see (“OTS”) distribution of a schedule of print or television media, comprising the steps of:
generating individual OTS distributions based on loyalty and casualness, wherein loyalty is a representation of the probability that an individual will read a print publication or view a television program according to a binomial distribution, and wherein casualness is the ratio of the additional reach of a succeeding issue over the reach of its preceeding issue to the additional reach of said succeeding isssue to an independent issue;
and summing said individual OTS distributions.

2. The method of claim 1 wherein said binomial distribution is beta-binomial.
